(19) United States
(12) Patent Application Publication
(10) Pub. No.: US 2026/0145375 A1
(43) Pub. Date: May 28, 2026

(54) MOLD FOR COMPOSITE MATERIAL AND METHOD FOR MANUFACTURING COMPOSITE MATERIAL

(71) Applicant: JTEKT CORPORATION, Kariya-shi, Aichi (JP)

(72) Inventors: Toshiyuki BABA, Kashihara-shi (JP); Koji KIMURA, Shiki-gun (JP); Tomoya ADACHI, Kashihara-shi (JP); Shintaro TSUJI, Kashihara-shi (JP)

(73) Assignee: JTEKT CORPORATION, Kariya-shi, Aichi (JP)

(21) Appl. No.: 19/121,610

(22) PCT Filed: Oct. 26, 2022
(86) PCT No.: PCT/JP2022/039957

§ 371 Date: Apr. 16, 2025

(51) Int. Cl. B29C 45/78; B29C 45/14

(52) U.S. Cl. CPC B29C 45/78; B29C 45/14778; B29C 2945/7604; B29C 2945/76287; B29C 2945/76294; B29C 2945/76531; B29C 2945/76739

(57) ABSTRACT

A mold for composite material including a metal member and a resin member joined to the metal member includes: a mold body including an internal space including a first space into which the metal member is inserted and a second space that is a cavity in which the resin member is molded; a first temperature sensor; and a second temperature sensor. A surface of the metal member exposed to the second space when the metal member is inserted into the first space is a joint surface. A plane coinciding with the position of the surface when the metal member is not inserted into the first space is an imaginary plane. The first temperature sensor faces the first space in a projection range of the imaginary plane in a direction normal to the imaginary plane. The second temperature sensor faces the second space in the projection range of the imaginary plane.

### TECHNICAL FIELD

The present invention relates to molds for a composite material and methods for manufacturing a composite material.

### BACKGROUND ART

Patent Document 1 below describes a method for manufacturing a composite material. This composite material is manufactured by joining a metal member and a resin member by injection molding. A mold used in this manufacturing method has a cavity into which the metal member is to be inserted and a cavity into which resin is to be injected. A temperature sensor is provided at the cavity into which the resin is to be injected. In this manufacturing method, parameters for a molding machine are adjusted based on the detection results from the temperature sensor. Patent Document 1 also discloses an estimation device that estimates joint strength between the metal member and the resin member. The joint strength between the metal member and the resin member is estimated from surface roughness of the metal member. This estimation device reduces manufacturing defects by estimating the joint strength before the composite material is manufactured.

### RELATED ART DOCUMENTS

### Patent Documents

Patent Document 1: Japanese Unexamined Patent Application Publication No. 2022-35285 (JP 2022-35285 A)

### SUMMARY OF THE INVENTION

### Problem to Be Solved by the Invention

The joint strength between a metal member and a resin member in a composite material is considered to be also affected by changes in temperature inside a mold during molding, for example, by the temperature at the joint between the metal member and the resin member. The technique described in Patent Document 1 only measures the temperature at one position in the mold that is located away from the joint. It is therefore difficult to know the temperature of the joint.

An object of the present disclosure is to provide a mold for a composite material and a method for manufacturing a composite material that allows to know the temperature of the joint between a metal member and a resin member.

### Means for Solving the Problem

(1) A mold for a composite material according to the present disclosure is a mold that molds a composite material including a metal member and a resin member joined to the metal member. The mold includes: a mold body including a first space into which the metal member is to be inserted and a second space that is a cavity in which the resin member is to be molded; a first temperature sensor; and a second temperature sensor. A surface of the metal member that is exposed to the second space when the metal member is inserted into the first space is a joint surface. A plane that coincides with a position of the joint surface when the metal member is not inserted into the first space is an imaginary plane. The first temperature sensor faces the first space present in a projection range of the imaginary plane in a direction normal to the imaginary plane. The second temperature sensor faces the second space present in the projection range of the imaginary plane.
(2) A method for manufacturing a composite material according to the present disclosure is a method for manufacturing a composite material including a metal member and a resin member joined to the metal member by using the mold according to (1). The method includes: a first step of measuring a temperature of the metal member inserted into the first space of the mold by the first temperature sensor; and a second step of, after the first step, measuring a temperature of the metal member inserted into the first space of the mold by the first temperature sensor and measuring a temperature of molten resin injected into the second space of the mold by the second temperature sensor.

### Effects of the Invention

The present disclosure allows to accurately know changes in temperature inside a mold.

### BRIEF DESCRIPTION OF THE DRAWINGS

FIG. 1 is a longitudinal section of a composite material.

FIG. 2 is a longitudinal section of a mold.

FIG. 3 is a transverse section of the mold.

FIG. 4 is a perspective view illustrating a projection range of a joint surface of a metal member.

FIG. 5 is a longitudinal section of the mold, showing a molding portion of a joint of the composite material.

FIG. 6 is a sectional view taken along line VI-VI in FIG. 5.

FIG. 7A is a sectional view illustrating a procedure for molding the composite material.

FIG. 7B is a sectional view illustrating the procedure for molding the composite material.

FIG. 7C is a sectional view illustrating the procedure for molding the composite material.

FIG. 8 is a graph showing changes in temperature of the metal member and a resin member.

FIG. 9 is a diagram illustrating transfer marks from protrusions of the mold.

### MODES FOR CARRYING OUT THE INVENTION

### Overview of Embodiments of the Invention of the Present Disclosure

Hereinafter, an overview of embodiments of the invention of the present disclosure will be listed and described.
(1) A mold for a composite material according to the present disclosure is a mold that molds a composite material including a metal member and a resin member joined to the metal member. The mold includes: a mold body including a first space into which the metal member is to be inserted and a second space that is a cavity in which the resin member is to be molded; a first temperature sensor; and a second temperature sensor. A surface of the metal member that is exposed to the second space when the metal member is inserted into the first space is a joint surface. A plane that coincides with a position of the joint surface when the metal member is not inserted into the first space is an imaginary plane. The first temperature sensor faces the first space present in a projection range of the imaginary plane in a direction normal to the imaginary plane. The second temperature sensor faces the second space present in the projection range of the imaginary plane.

The mold with the above configuration can measure the temperature of the metal member and the temperature of the resin member at the joint between the metal member and the resin member. Therefore, with the mold with the above configuration, it is possible to know the temperature of the joint, for example, the temperature of the joint surface located at the boundary between the metal member and the resin member (such as transfer of heat from the resin member to the metal member). The temperature of the joint affects joint strength between the resin member and the metal member. For example, it is therefore possible to estimate the joint strength between the metal member and the resin member using information indicating changes in these temperatures, or to control the temperature of the mold body etc. while observing these temperatures, in order to obtain desired joint strength. By associating information obtained by quantifying the measured temperatures with the joint strength, this information can be used to design molding conditions for composite materials.
(2) According to a mold of (2), in the mold of (1), an inner surface of the mold body that faces the imaginary plane in the second space includes a plurality of protrusions and recesses. The protrusions and recesses are either or both of protrusions and recesses. With this configuration, the mold of (2) forms a plurality of transfer marks on the molded resin member. The plurality of transfer marks is a plurality of recesses or protrusions formed as a result of transfer of the plurality of protrusions or recesses. Molten resin melted by heating is injected into the mold. The injected molten resin solidifies into the resin member when cooled inside the mold. When the resin member is cooled after the solidification, it shrinks to a great extent, especially in the regions other than the joint with the metal member. The relative positions and shapes of the plurality of transfer marks change as a result of this shrinkage. Changes in relative positions and shapes of the protrusions and recesses of the mold caused by the cooling are negligibly small compared to the changes in relative positions and shapes of the plurality of transfer marks on the resin member. Therefore, displacements of the relative positions and shapes of the plurality of transfer marks on the resin member with respect to the relative positions and shapes of the protrusions and recesses of the mold are related to changes in length and volume of the resin member caused by the shrinkage due to the cooling after the solidification. The changes in length and volume of the resin member due to the shrinkage are related to residual stress (internal stress) generated in the resin member. The residual stress affects the joint strength between the metal member and the resin member. Therefore, knowing the changes in length and volume of the resin member due to the shrinkage allows to estimate, for example, the joint strength between the metal member and the resin member, and is also useful in designing molding conditions for composite materials.
(3) According to a mold of (3), in the mold of (1) or (2), an inner surface of the mold body that extends in a direction crossing the imaginary plane in the second space includes a plurality of protrusions and recesses. With this configuration, the mold of (3) forms transfer marks on the molded resin member as in (2). Knowing displacements of the relative positions and shapes of the plurality of transfer marks with respect to the relative positions and shapes of the protrusions and recesses of the mold allows to know changes in length and volume of the resin member caused by the shrinkage. Knowing the changes in length and volume of the resin member due to the shrinkage allows to estimate the joint strength between the metal member and the resin member, and is also useful in designing molding conditions for composite materials.
(4) A method for manufacturing a composite material according to the present disclosure is a method for manufacturing a composite material including the metal member according to any one of (1) to (3) and a resin member joined to the metal member by using the mold according to any one of claims 1 to 3. The method includes: a first step of measuring a temperature of the metal member inserted into the first space of the mold by the first temperature sensor; and a second step of, after the first step, measuring the temperature of the metal member inserted into the first space of the mold by the first temperature sensor and measuring a temperature of molten resin injected into the second space of the mold by the second temperature sensor.

In this manufacturing method, the temperature of the metal member can be measured by the first temperature sensor before and after the resin member is injected into the second space, and the temperatures of the injected molten resin and the resin component formed by solidification of the molten resin can be measured by the second temperature sensor. Knowing a change in temperature of the metal member and a change in temperature of the resin member allows to estimate a change in heat transferred from the molten resin or the resin member to the metal member. The change in temperature of the metal member and the change in temperature of the resin member can be related to the changes in length and volume of the resin member due to the shrinkage and the joint strength with the metal member.
(5) According to a manufacturing method of (5), in the manufacturing method of (4), a temperature before the molten resin is injected into the second space is measured by the second temperature sensor in the first step. The manufacturing method of (5) allows to know a change in temperature before and after injection of the molten resin into the second space.

### Details of Embodiments of Invention of Present Disclosure

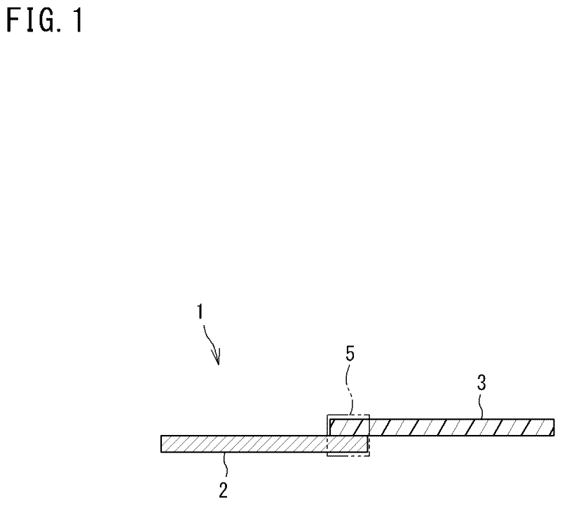

Embodiments of the present disclosure will be described in detail below. FIG. 1 is a longitudinal section of a composite material. A composite material 1 of the present embodiment includes a metal member 2 and a resin member 3. The metal member 2 is, for example, aluminum or an aluminum alloy. However, the metal member 2 may be any metal that can be inserted into a mold by injection molding such as iron, stainless steel, or magnesium. The metal member 2 of the present embodiment is in the shape of a long, narrow strip, and the metal member 2 is manufactured from a plate material. The shape of the metal member 2 can be changed to any suitable shape.

The resin member 3 is made of an engineering plastic such as PBT (polybutylene terephthalate), PPS (polyphenylene sulfide), or PA (polyamide). However, the resin member 3 may be made of any resin that can be injection molded. The resin member 3 is in the shape of a long, narrow strip, and the resin member 3 is manufactured from a plate material. The shape of the resin member can be changed to any suitable shape.

The metal member 2 is substantially in the shape of a rectangular parallelepiped. The longest side of the metal member 2 is the width. The shortest side of the metal member 2 is the height. The side of the metal member 2 that is neither the width nor the height is the depth. The direction of the width is a longitudinal direction. The direction of the height is a height direction. The direction of the depth is a depth direction. One longitudinal end of the metal member 2 and one longitudinal end of the resin member 3 are joined together in an overlapping manner. Hereinafter, a portion (portion surrounded by a long dashed double-short dashed line in FIG. 1) 5 where the metal member 2 and the resin member 3 overlap each other is referred to as “joint.” The composite material 1 is manufactured by injection molding using a mold 9 described below. In the injection molding, the metal member 2 is used as an insert, and the resin member 3 that is a molded component formed as injected molten resin 3′ solidifies and the metal member 2 are joined into a single component.

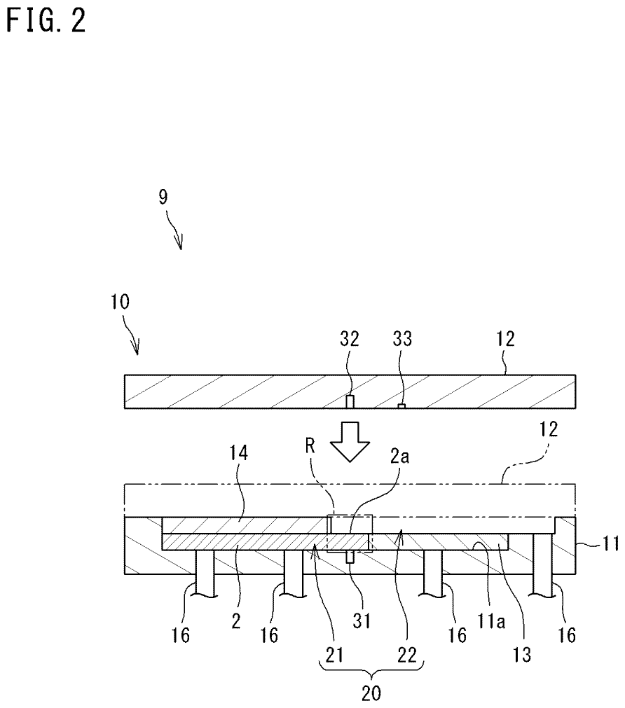

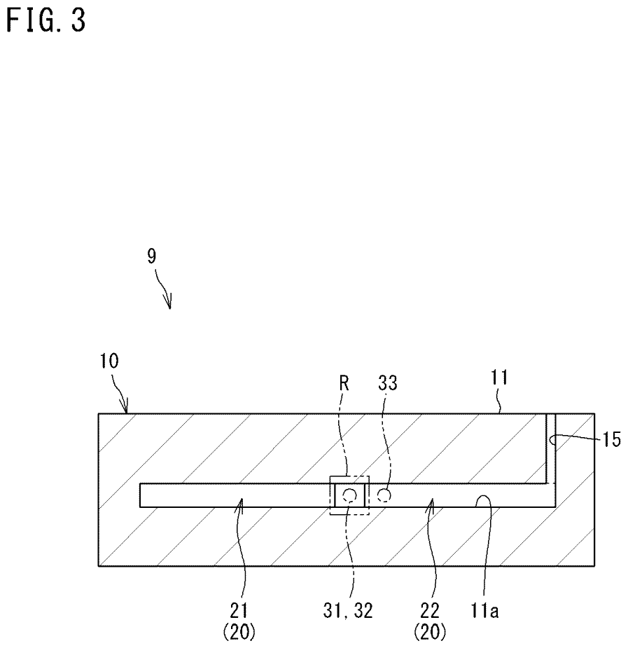

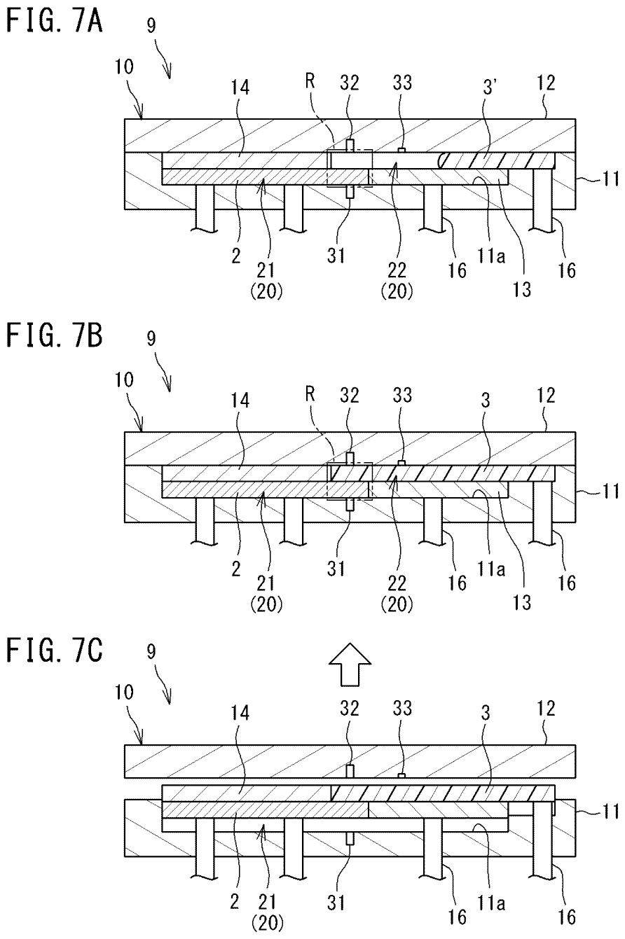

FIG. 2 is a longitudinal section of the mold. FIG. 3 is a transverse section of the mold. The mold 9 includes a mold body 10, temperature sensors 31, 32, and a pressure sensor 33. The mold body 10 includes a lower mold 11, an upper mold 12, and mold parts 13, 14. The lower mold 11 has a recessed portion 11a. After the mold part 13 and the mold part 14 are placed in the recessed portion 11a of the lower mold 11, the recessed portion 11a of the lower mold 11 is closed with the upper mold 12. An internal space 20 is thus formed inside the mold body 10. The internal space 20 includes a first space 21 and a second space 22. The metal member 2 is placed in the first space 21. After the mold part 13, the mold part 14, and the metal member 2 are placed in the recessed portion 11a of the lower mold 11, the recessed portion 11a of the lower mold 11 is closed with the upper mold 12. The second space 22 that serves as a cavity is thus formed inside the mold body 10. The molten resin 3′ (see FIG. 7A) is injected into the second space 22. The molten resin 3′ solidifies into the resin member 3 in the second space 22. As the molten resin 3′ solidifies in the second space 22, it is joined to the metal member 2. The resin member 3 and the metal member 2 are thus joined into a single component that is the composite material 1. The lower mold 11 or the upper mold 12 includes an injection channel 15 (see FIG. 3) through which the molten resin 3′ is injected into the second space 22.

Ejector pins (pushing tools) 16 are placed in the lower mold 11. The ejector pins (pushing tools) 16 release the composite material 1 from the lower mold 11.

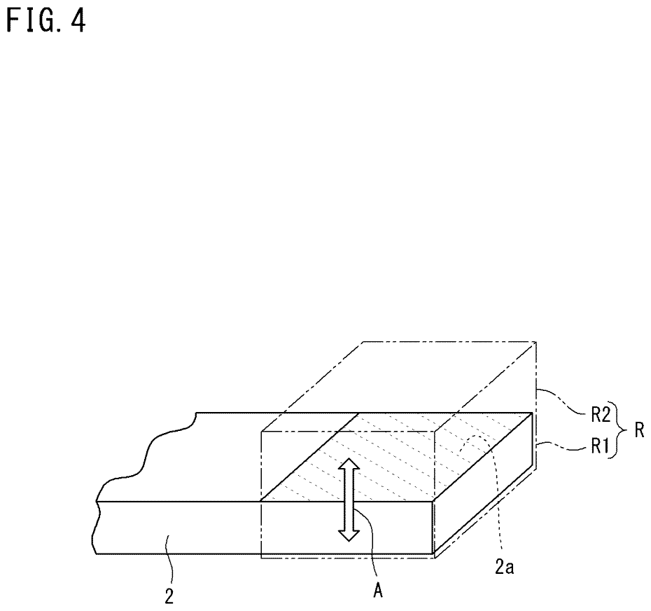

In FIGS. 2 and 3, a portion surrounded by a long dashed double-short dashed line represents a projection range R obtained by projecting such a surface of the metal member 2 inserted into the first space 21 that is exposed to the second space 22, that is, a joint surface 2a of the metal member 2 to the resin member 3, in upward and downward directions (i.e., directions normal to the joint surface 2a). More specifically, as shown in FIG. 4, the projection range R is a three-dimensional region substantially in the shape of a prism or a rectangular parallelepiped. The projection range R includes a range (space) R2 obtained by projecting the joint surface 2a (portion hatched with dashed lines) of the metal member 2 upward (toward one side in a normal direction A), and a range (space) R1 obtained by projecting the joint surface 2a downward (toward the other side in the normal direction A). The projection range R can also be said to be a spatial region in which the joint 5 shown in FIG. 1 is formed by molding. In FIGS. 2 to 4 and FIGS. 5 to 7 described below, the projection range R is shown slightly larger than its actual size in order to avoid overlapping lines for better understanding of the projection range R.

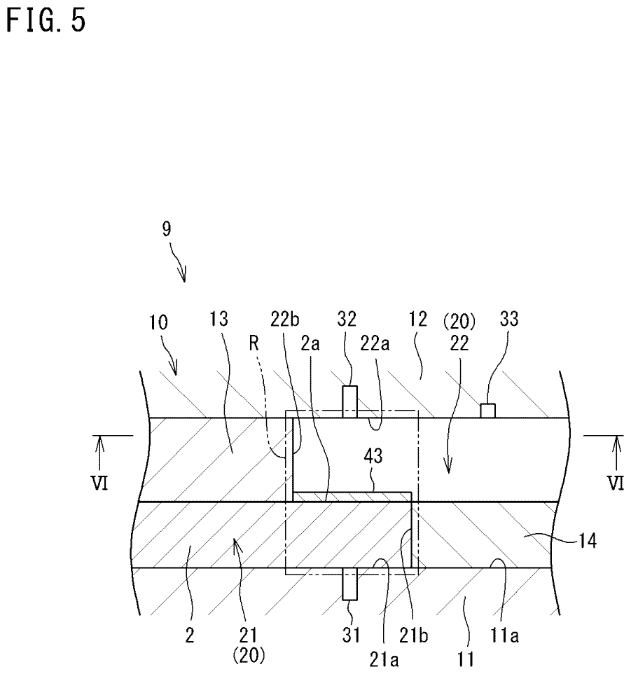

FIG. 5 is a longitudinal section of the mold, showing a molding portion of the joint of the composite material. As shown in FIG. 5, the mold 9 of the present embodiment includes the first temperature sensor 31 and the second temperature sensor 32. The surface of the metal member 2 that is exposed to the second space 22 when the metal member 2 is inserted into the first space 21 of the lower mold 11 is the joint surface 2a. A plane that coincides with the position of the joint surface 2a when the metal member 2 is not inserted into the first space 21 is an imaginary plane 2a. Therefore, a projection range R of the imaginary plane 2a coincides with the projection range R of the joint surface 2a. The first temperature sensor 31 is provided in the lower mold 11. The first temperature sensor 31 faces the first space 21 present in the projection range R of the imaginary plane 2a. More specifically, the first temperature sensor 31 is provided at an inner surface 21a (surface forming the first space 21; specifically, the bottom surface of the recessed portion 11a of the lower mold 11) of the mold body 10. The inner surface 21a contacts the opposite surface of the metal member 2 from the imaginary plane 2a. The first temperature sensor 31 faces the first space 21 present in the projection range R of the imaginary plane 2a in a direction normal to the imaginary plane 2a. Therefore, the first temperature sensor 31 measures the temperature of the metal member 2. The temperature measured by the first temperature sensor 31 is substantially the temperature of the metal member 2.

The first temperature sensor 31 may be provided at any other position as long as it faces the first space 21 present in the projection range R of the imaginary plane 2a. For example, the first temperature sensor 31 may be provided at an inner surface 21b of the mold body 10 that extends in a direction crossing the imaginary plane 2a and that forms the first space 21.

The second temperature sensor 32 is provided in the upper mold 12. The second temperature sensor 32 faces the second space 22 present in the projection range R of the imaginary plane 2a. More specifically, the second temperature sensor 32 is provided at an inner surface 22a (surface forming the second space 22; specifically, the lower surface of the upper mold 12) of the mold body 10. The inner surface 22a faces the imaginary plane 2a and forms the second space 22. The second temperature sensor 32 faces the second space 22 present in the projection range R of the imaginary plane 2a. Therefore, the second temperature sensor 32 measures the temperature of the second space 22, namely a cavity, before the molten resin 3′ is injected, the temperature of the molten resin 3′ while the molten resin 3′ is being injected, and the temperature of the resin member 3 formed as a result of solidification of the molten resin 3′. The temperature measured by the second temperature sensor 32 is substantially any one of the following temperatures: the temperature of the second space 22, the temperature of the molten resin 3′, and the temperature of the resin member 3.

The second temperature sensor 32 may be provided at any other position as long as it faces the second space 22 present in the projection range R of the imaginary plane 2a. For example, the second temperature sensor 32 may be provided at an inner surface 22b of the mold body 10 that extends in a direction crossing the imaginary plane 2a and that forms the second space 22.

As shown in FIG. 5, the mold 9 includes the pressure sensor 33. The pressure sensor 33 is provided at a position outside the projection range R of the imaginary plane 2a but near the projection range R. Specifically, the pressure sensor 33 is provided at the inner surface 22a of the mold body 10 (lower surface of the upper mold 12) that forms the second space 22. The pressure sensor 33 measures the pressure of the molten resin 3′ injected into the second space 22. This pressure is proportional to the filling density of the molten resin 3′ in the second space 22. The pressure sensor 33 may face the second space 22 present in the projection range R of the imaginary plane 2a, like the second temperature sensor 32.

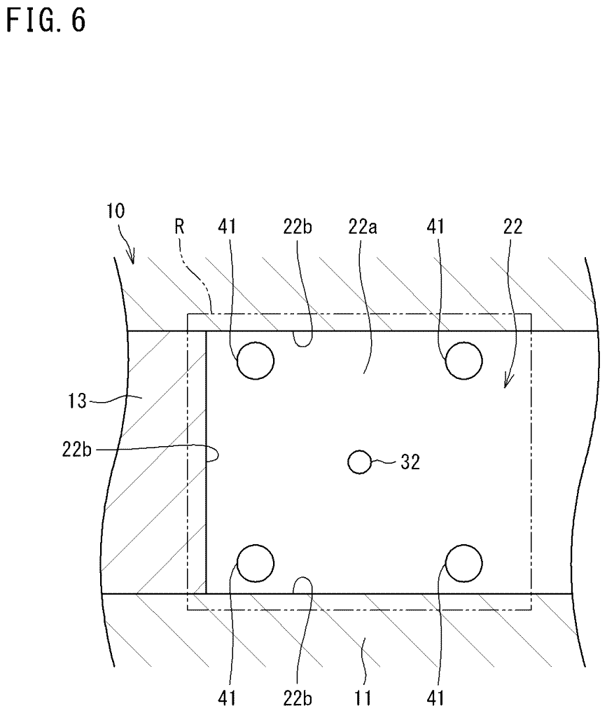

FIG. 6 is a sectional view taken along line VI-VI in FIG. 5. A plurality of protrusions and recesses 41 is provided on the inner surface 22a of the mold body 10 that faces the joint surface 2a of the metal member 2, specifically, on the lower surface of the upper mold 12 that is located above the imaginary plane 2a. The protrusions and recesses 41 of the mold of the present embodiment are protrusions 41. The mold of the present embodiment has four protrusions 41. Each protrusion 41 has a cylindrical shape and protrudes from the lower surface of the upper mold 12. The positions and shape(s) of the four protrusions 41 are known in advance. The relative positional relationship among the four protrusions 41 and the shape(s) of the four protrusions 41 are determined in advance. In the mold body 10 of the present embodiment, the four protrusions 41 are arranged at positions corresponding to the four corners of a square (this arrangement will be referred to as square shape). Each protrusion 41 forms a recess as a transfer mark in the resin member 3 molded in the second space 22.

The four protrusions 41 may be arranged at positions corresponding to the four corners of a rectangle other than a square (rectangular shape), at positions corresponding to the four corners of a rhombus (rhombic shape), or at positions corresponding to the four corners of a parallelogram (parallelogrammatic shape). The number of protrusions 41 is two or more. The number of protrusions 41 is preferably three or more. Depending on the number of protrusions 41, the plurality of protrusions 41 may be arranged at positions corresponding to the three corners of a triangle (triangular shape), at positions corresponding to the five corners of a pentagon (pentagonal shape), or at other positions corresponding to the corners of a polygon (polygonal shape). Instead of the plurality of protrusions 41, a plurality of recesses may be provided on the inner surface 22a of the mold body 10. In this case, each recess forms a protrusion as a transfer mark in the resin member 3 molded in the second space 22.

As shown in FIG. 5, an adhesive 43 is provided on the joint surface 2a of the metal member 2 placed in the first space 21. The resin member 3 molded in the second space 22 is bonded to the metal member 2 by the adhesive 43.

FIG. 7A to 7C are sectional views illustrating a procedure for molding the composite material. The procedure for molding the composite material 1 will be described with reference to FIGS. 7A to 7C. FIG. 7A shows a first state. The first state is a state in which the two mold parts 13, 14 have been placed in the recessed portion 11a of the lower mold 11 and the metal member 2 has been inserted in the first space 21. The first state is a state in which the molten resin 3′is being injected into the second space 22.

FIG. 7B shows a second state. The second state is a state in which the molten resin 3′has been injected into the second space 22. In the second state, a pressure is being applied in the internal space 20, and the molten resin 3′ conforms to the engraved pattern of the first space 21 (cavity) of the mold body 10. Thereafter, the molten resin 3′ is cooled, and thus, solidifies into the resin member 3. When the molten resin 3′ solidifies, the metal member 2 and the resin member 3 are joined into the composite material 1. During the steps up to this point, the first temperature sensor 31 measures the temperature of the metal member 2, the second temperature sensor 32 measures the temperature of the second space 22 that is a cavity before the molten resin 3′is injected, the temperature of the molten resin 3′ while the molten resin 3′ is being injected, and the temperature of the resin member 3 formed as a result of solidification of the molten resin 3′, and the pressure sensor 33 measures the pressure of the molten resin 3′ injected into the second space 22.

FIG. 7C shows a third state. After the composite material 1 is molded, the upper mold 12 of the mold body 10 is removed from the lower mold 11, and the molded composite material 1 together with the two mold parts 13, 14 is removed from the recessed portion 11a of the lower mold 11 by the ejector pins 16.

When the composite material 1 is molded by the above steps, the resin member 3 shrinks as it is cooled in the cooling step. Part of the resin member 3 is joined to the joint surface 2a of the metal member 2. The amount of shrinkage of the resin member 3 is small near the joint surface 2a, and increases as it gets farther from the joint surface 2a. Therefore, part of the resin member 3 that is located near the joint surface 2a tends to be subjected to internal stress (residual stress) as the shrinkage is restricted. This residual stress affects bonding strength between the metal member 2 and the resin member 3 at the joint surface 2a. Therefore, knowing the degree to which the resin member 3 shrinks is useful in estimating and managing the bonding strength.

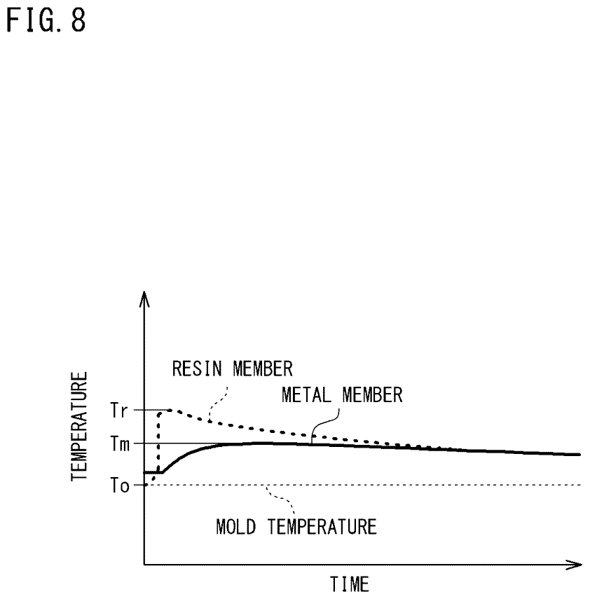

FIG. 8 is a graph showing changes in temperature of the metal member and the resin member. For example, the temperature of the metal member 2 measured by the first temperature sensor 31 and the temperature of the resin member 3 measured by the second temperature sensor 32 change in a manner shown in shown in FIG. 8. In a state immediately before the molten resin 3′ is injected into the second space 22, a measurement value of the first temperature sensor 31 and a measurement value of the second temperature sensor 32 are both approximately the same as, or close to, the temperature To of the mold body 10. The temperature of the mold body 10 is controlled to be constant by a control device, not shown.

When the molten resin 3′is injected into the second space 22, the measurement value of the second temperature sensor 32 rapidly increases to the temperature Tr of the molten resin 3′ as the second temperature sensor 32 comes into contact with the molten resin 3′. The heat of the molten resin 3′ is gradually transferred to the metal member 2, causing the temperature of the metal member 2 to rise. As the temperature of the metal member 2 rises, the measurement value of the first temperature sensor 31 gradually increases. The heat of the molten resin 3′ is absorbed by the mold 9 and the metal member 2. The measurement value of the second temperature sensor 32 therefore gradually decreases. After the measurement value of the first temperature sensor 31 reaches its peak Tm, the measurement value of the first temperature sensor 31 and the measurement value of the second temperature sensor 32 converge to the same temperature and both gradually decrease.

As described above, with the mold 9 of the present embodiment, it is possible to know changes in temperature of the joint 5 of the composite material 1 because the first temperature sensor 31 measures the temperature of the metal member 2 and the second temperature sensor 32 measures the temperature of the resin member 3 (molten resin 3′). In particular, with the mold 9 of the present embodiment, it is possible to know the temperature near the joint surface 2a located at the boundary between the metal member 2 and the resin member 3. For example, it is possible to know transfer of heat from the resin member 3 to the metal member 2 through the joint surface 2a.

Changes in temperature of the joint 5 affect the joint strength between the metal member 2 and the resin member 3. For example, the joint strength of the joint 5 may decrease when the temperature of the joint 5 is too low or too high. The use of the mold 9 of the present embodiment allows to know changes in temperature of the joint 5 during manufacturing of the composite material 1. This makes it possible to associate the changes in temperature with the joint strength between the metal member 2 and the resin member 3, optimize the molding temperature from data obtained by the association, estimate the joint strength from the changes in temperature, and control the temperature of the mold body 10 while observing the changes in temperature. With the mold 9 of the present embodiment, it is possible to achieve appropriate joint strength by utilizing data on the changes in temperature of the joint 5. It is also possible to reduce variation in quality of the composite material 1 by monitoring the changes in temperature of the joint 5.

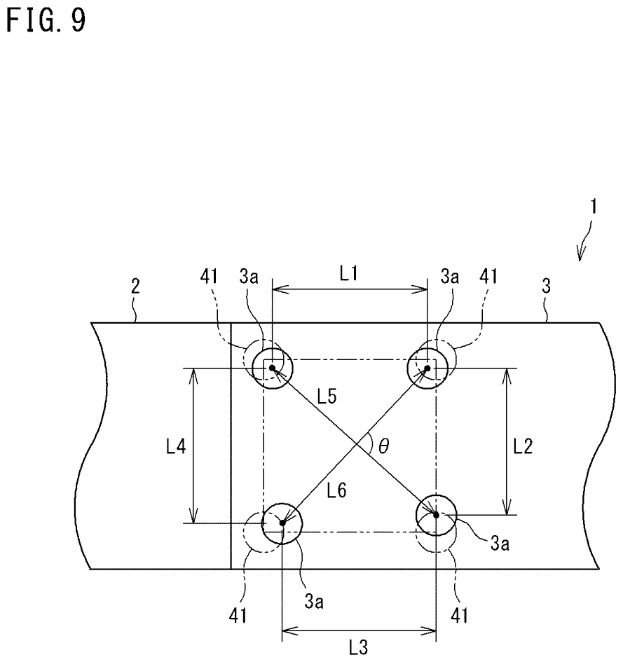

FIG. 9 is a diagram illustrating transfer marks from the protrusions of the mold. There are four recesses 3a at the surface of the resin member 3 of the molded composite material 1 as transfer marks from the protrusions 41 (see FIG. 6) on the mold body 10. After injection molding, the resin member 3 of the composite material 1 shrinks as it is cooled. If the resin member 3 does not shrink, the four recesses 3a transferred to the resin member 3 are arranged in a square shape like the arrangement of the protrusions 41 (shown by long dashed double-short dashed lines in FIG. 9). Since the resin member 3 shrinks, the relative positions of the four recesses 3a change. For example, the distances L1 to L4 between adjacent recesses 3a, the distances L5, L6 between diagonally positioned recesses 3a, the angle θ between two diagonals, etc. change. The shape of the recesses 3a also changes with respect to the shape of the protrusions 41. Therefore, measuring these values L1 to L6, θ and analyzing changes in position of the recesses 3a and the shapes of the recesses 3a allows to know changes in shrinkage (amount of shrinkage, shrinkage direction, etc.) of the resin member 3. Parameters other than the above distances and angles of the four recesses 3a may be used to know the changes in shrinkage of the resin member 3.

The changes in shrinkage of the resin member 3 are related to the filling density of the molten resin 3′ in the second space 22 of the mold body 10. The higher the filling density of the molten resin 3′, the smaller the shrinkage of the resin member 3. Based on the fact that the filling density of the molten resin 3′ is proportional to the pressure in the second space 22, changes in pressure obtained from the measurement value of the pressure sensor 33 can be used to estimate the filling density of the molten resin 3′. Therefore, the changes in pressure obtained from the measurement value of the pressure sensor 33 can be used to know the changes in shrinkage of the resin member 3.

Moreover, as described above, a part of the resin member 3 located near the joint surface 2a of the metal member 2 shrinks to a small extent due to restriction of the shape of the resin member 3. However, the restriction decreases as the resin member 3 gets farther away from the joint surface 2a. Therefore, another part of the resin member 3 located away from the joint surface 2a shrinks to a great extent. Therefore, the part of the resin member 3 located near the joint surface 2a is pulled by the joint surface 2a, and tends to be subjected to residual stress such as tensile stress. This residual stress is correlated with changes in shrinkage of the resin member 3, and also affects the joint strength between the metal member 2 and the resin member 3.

Therefore, with the injection molding using the mold 9 of the present embodiment, it is possible to know changes in shrinkage of the resin member 3 by using the relative positional relationship among the four recesses 3a formed in the resin member 3, the shapes of the recesses 3a, the measurement value of the pressure sensor 33, etc., and to estimate the joint strength between the metal member 2 and the resin member 3 from the changes in shrinkage. Controlling the filling speed and filling amount of the molten resin 3′ while observing the pressure of the molten resin 3′ allows the composite material 1 that is a molded product to have appropriate joint strength, and reduces variation in quality.

By accumulating data on the measurement values of the temperature sensors 31, 32, the measurement values of the pressure sensor 33, and features (e.g., integral values, maximum values, minimum values, slopes of graphs, etc.) calculated using these measurement values, and analyzing the relationship between the data and the joint strength of the composite material 1 obtained by a tensile test etc. after molding, or by analyzing the adhesion mechanism from the data, the analysis results can be reflected in model-based development for manufacturing and design of the composite material 1.

### Others

The above embodiment is illustrative in all respects and is not restrictive. The scope of rights of the present invention is set forth in the claims, and is intended to include all modifications within the meaning and scope equivalent to the claims.

For example, the joint surface 2a of the metal member 2 does not have to be a flat surface, and may be a curved surface or a bent surface. In any case, the temperature sensors 31, 32 are disposed so as to face the first space 21 or the second space 22 that is present in the projection range R in the direction normal to the joint surface 2a or an imaginary plane corresponding to the joint surface 2a.

### DESCRIPTION OF THE REFERENCE NUMERALS

1 . . . composite material, 2 . . . metal member, 2a . . . joint surface, 3 . . . resin member, 9 . . . mold, 10 . . . mold body, 20 . . . internal space, 21 . . . first space, 22 . . . second space, 31 . . . first temperature sensor, 32 . . . second temperature sensor, 41 . . . protrusion, A . . . normal direction, R . . . projection range

1. A mold for a composite material, the mold being configured to mold the composite material including a metal member and a resin member joined to the metal member, the mold comprising:
a mold body including an internal space, the internal space including a first space into which the metal member is to be inserted and a second space that is a cavity in which the resin member is to be molded;
a first temperature sensor; and
a second temperature sensor, wherein:
a surface of the metal member that is exposed to the second space when the metal member is inserted into the first space is a joint surface;
a plane that coincides with a position of the joint surface when the metal member is not inserted into the first space is an imaginary plane;
the first temperature sensor faces the first space present in a projection range of the imaginary plane in a direction normal to the imaginary plane; and
the second temperature sensor faces the second space present in the projection range of the imaginary plane.

2. The mold for the composite material according to claim 1, wherein an inner surface of the mold body that faces the imaginary plane in the second space includes a plurality of protrusions and recesses, and the protrusions and recesses are either or both of protrusions and recesses.

3. The mold for the composite material according to claim 1, wherein an inner surface of the mold body that extends in a direction crossing the imaginary plane in the second space includes a plurality of protrusions and recesses.

4. A method for manufacturing a composite material including a metal member and a resin member joined to the metal member by using the mold according to claim 1, the method comprising:
a first step of measuring a temperature of the metal member inserted into the first space of the mold by the first temperature sensor; and
a second step of, after the first step, measuring the temperature of the metal member inserted into the first space of the mold by the first temperature sensor and measuring a temperature of molten resin injected into the second space of the mold by the second temperature sensor.

5. The method for manufacturing the composite material according to claim 4, wherein in the first step, a temperature of the second space before the molten resin is injected into the second space is measured by the second temperature sensor.

6. A method for manufacturing a composite material including a metal member and a resin member joined to the metal member by using the mold according to claim 2, the method comprising:
a first step of measuring a temperature of the metal member inserted into the first space of the mold by the first temperature sensor; and
a second step of, after the first step, measuring the temperature of the metal member inserted into the first space of the mold by the first temperature sensor and measuring a temperature of molten resin injected into the second space of the mold by the second temperature sensor.

7. A method for manufacturing a composite material including a metal member and a resin member joined to the metal member by using the mold according to claim 3, the method comprising:
a first step of measuring a temperature of the metal member inserted into the first space of the mold by the first temperature sensor; and
a second step of, after the first step, measuring the temperature of the metal member inserted into the first space of the mold by the first temperature sensor and measuring a temperature of molten resin injected into the second space of the mold by the second temperature sensor.

8. The method for manufacturing the composite material according to claim 6, wherein in the first step, a temperature of the second space before the molten resin is injected into the second space is measured by the second temperature sensor.

9. The method for manufacturing the composite material according to claim 7, wherein in the first step, a temperature of the second space before the molten resin is injected into the second space is measured by the second temperature sensor.
